(19) United States
(12) Patent Application Publication
(10) Pub. No.: US 2018/0072905 A1
(43) Pub. Date: Mar. 15, 2018

(54) INKJET INK

(71) Applicant: Roland DG Corporation, Hamamatsu-shi (JP)

(72) Inventors: Shinji TABUCHI, Hamamatsu-shi (JP); Aoi TANAKA, Hamamatsu-shi (JP)

(21) Appl. No.: 15/679,239

(22) Filed: Aug. 17, 2017

(30) Foreign Application Priority Data
Sep. 15, 2016 (JP) 2016-180243

(51) Int. Cl. C09D 11/36; C09D 11/38; C09D 11/102; B41J 2/175

(52) U.S. Cl. CPC C09D 11/36; B41J 2/175; C09D 11/102; C09D 11/38

(57) ABSTRACT

An inkjet ink includes at least water, a coloring material, a water-soluble organic solvent component, resin particles, and a surfactant. 3-methoxy-1-butanol is preferably provided as the water-soluble organic solvent component in the inkjet ink at a content of 8% by mass or greater. The surfactant is included in the inkjet ink at a content of 2% by mass or less. The inkjet ink has a static surface tension, determined by the Wilhelmy method, of about 27.0 mN/m or less at 25° C.

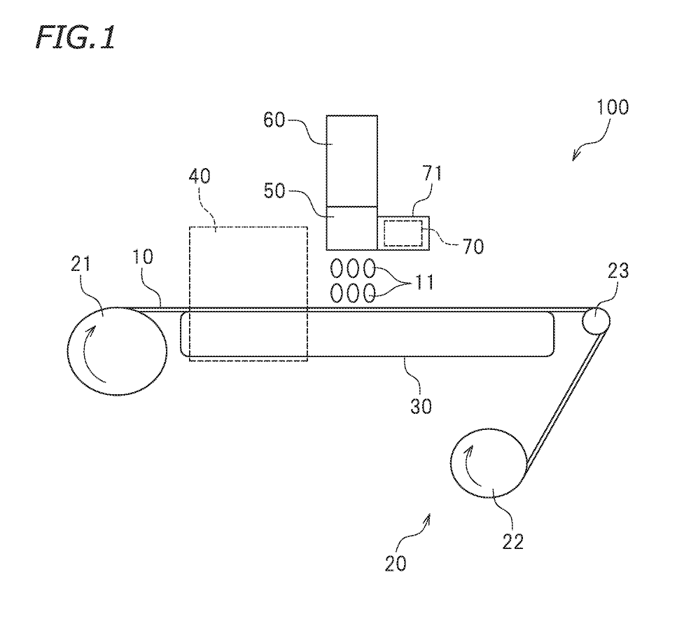

### CROSS REFERENCE TO RELATED APPLICATIONS

This application claims the benefit of priority to Japanese Patent Application No. 2016-180243 filed on Sep. 15, 2016. The entire contents of this application are hereby incorporated herein by reference.

### BACKGROUND OF THE INVENTION

### 1. Field of the Invention

The present invention relates to inkjet inks.

### 2. Description of the Related Art

An inkjet printer using an inkjet recording system has the advantages of, for example, being easy to operate, generating little noise, and allowing color printing to be performed easily, and thus is in wide use as a home-use or office-use output device. Recently, an inkjet printer is also applied to industrial uses for, for example, displays, posters, signboards and the like.

The inkjet recording system is a recording system that directly ejects an ink liquid drop toward a medium from a very small nozzle and causes the ink liquid drop to adhere to the medium, thus providing a letter or an image. For industrial uses, a non-absorbent substrate is often used as a medium. One representative non-absorbent substrate is a poly(vinyl chloride) (PVC) substrate.

For printing (for forming an image) on a PVC substrate, an eco-solvent-based inkjet ink containing a glycolether-based solvent and a resin-soluble solvent (e.g., lactone, etc.) is suitable. The eco-solvent-based inkjet ink dissolves a surface of the PVC substrate and coats the surface of the PVC substrate with a pigment and a fixing resin to form an image. Therefore, the eco-solvent-based inkjet ink provides a high image quality with little ink bleeding, and has a high adhesion and a high waterproofness. During the image formation, the eco-solvent-based inkjet ink is penetration-dried and evaporation-dried, and therefore is dried very quickly.

However, there is a concern that the volatilized solvent of the eco-solvent-based inkjet ink may adversely influence the environment and the human body. Therefore, aqueous inkjet inks suitable for printing on a PVC substrate are desired and are now being progressively developed. Such aqueous inkjet inks typically include water, a water-soluble organic solvent, a coloring material, and resin microparticles as a fixing component (see, for example, Japanese Laid-Open Patent Publication No. 2015-193788).

In the case where the aqueous inkjet ink containing the above-described resin microparticles is used for printing on a PVC substrate, evaporation drying is mainly performed, rather than penetration drying. Since the aqueous inkjet ink contains water, how easily the aqueous inkjet ink is dried is important. In the case where a conventional aqueous inkjet ink is used, it is a usual practice to raise the temperature of the PVC substrate in order to promote drying immediately after the printing. It is conceivable to heat the PVC substrate to a high temperature (e.g., 70° C. or higher) in order to dry the aqueous inkjet ink within a short time period, but this is disadvantageous in terms of energy consumption. In the case where the printing medium is heat resistant, there is no problem if the printing medium is heated to a high temperature. In the case where the printing medium is an adhesive label including a substrate and a pressure-sensitive adhesive layer, the pressure-sensitive adhesive layer is softened when heated. As a result, the substrate and the pressure-sensitive adhesive layer may be shifted with respect to each other. For this reason, a printer having a print-and-cut function should not heat the medium to a high temperature before or after the medium is dried. By contrast, in the case where the medium is dried at a low temperature (e.g., about 50° C.), the drying speed is decreased and thus the productivity is decreased. In addition, in the case where the medium is dried at a low temperature, the solvent is likely to remain in a film of the applied ink, which decreases the waterproofness of the ink or the image quality. For these reasons, it is desired to develop an aqueous inkjet ink, usable for printing on a PVC substrate, that is high in each of a quick drying property, waterproofness and image quality even when being dried at a relatively low temperature (e.g., about 50° C.)

### SUMMARY OF THE INVENTION

Preferred embodiments of the present invention provide inkjet inks that are, when used to print on a PVC substrate, high in each of a quick drying property, waterproofness and image quality even when being dried at a relatively low temperature.

An inkjet ink according to a preferred embodiment of the present invention includes at least water (A); a coloring material (B); a water-soluble organic solvent component (C); resin particles (D); and a surfactant (E). 3-methoxy-1-butanol is preferably used as the water-soluble organic solvent component (C) in the inkjet ink at a content of 8% by mass or greater. The surfactant (E) is included in the inkjet ink at a content of 2% by mass or less. The inkjet ink has a static surface tension, determined by the Wilhelmy method, of about 27.0 mN/m or less at 25° C.

An inkjet recording method according to a preferred embodiment of the present invention includes the steps of ejecting the above-described inkjet ink toward a medium including a non-absorbent substrate; and drying the inkjet ink ejected on the medium to form an ink film.

An inkjet recording device according to a preferred embodiment of the present invention includes a conveyor that transports a medium including a non-absorbent substrate; a heater that heats the transported medium; an ejector that ejects an inkjet ink toward the heated medium; and an ink container that contains the inkjet ink and supplies the inkjet ink to the ejector. The inkjet ink is preferably the above-described inkjet ink.

The inkjet inks according to various preferred embodiments of the present invention are, when used to print on a PVC substrate, high in each of a quick drying property, waterproofness and image quality even when being dried at a relatively low temperature.

The above and other elements, features, steps, characteristics and advantages of the present invention will become more apparent from the following detailed description of the preferred embodiments with reference to the attached drawings.

### BRIEF DESCRIPTION OF THE DRAWINGS

The FIGURE is a conceptual view of an inkjet recording device according to a preferred embodiment of the present invention.

### DETAILED DESCRIPTION OF THE PREFERRED EMBODIMENTS

An inkjet ink according to a preferred embodiment of the present invention includes at least water (A), a coloring material (B), a water-soluble organic solvent component (C), resin microparticles (D), and a surfactant (E). The ink preferably includes, as the aqueous organic solvent component (C), 3-methoxy-1-butanol at a content of 8% by mass or greater. The content of the surfactant (E) in the ink is 2% by mass or less. The ink has a static surface tension, determined by the Wilhelmy method, of about 27.0 mN/m or less at 25° C.

The inkjet ink according to a preferred embodiment of the present invention includes water (A), and therefore, is aqueous inkjet ink. Due to the water (A), the inkjet ink has an advantage of having a small environmental load. There is no specific limitation on the type of water (A) used in the inkjet ink. From the point of view of preventing incorporation of impurities, ion exchange water, ultrafiltration water, reverse osmosis water, distilled water, and ultrapure water are preferable. Ion exchange water is more preferable.

The content of the water (A) in the inkjet ink according to a preferred embodiment of the present invention is preferably 40% by mass or greater, more preferably 45% by mass or greater, and still more preferably 50% by mass or greater. The content of the water (A) in the inkjet ink according to a preferred embodiment of the present invention is preferably 80% by mass or less, more preferably 75% by mass or less, and still more preferably 70% by mass or less.

As the coloring material (B), for example, a dye, a pigment or the like may be used. A single type of coloring material may be used, or two or more types of coloring materials may be combined at any ratio.

As the dye, any of various dyes known to be usable for aqueous inkjet ink may be used. Examples of such dyes include a direct dye, an acid dye, a food dye, a basic dye, a reactive dye, a dispersion dye, a vat color dye, and the like.

The dye will be described in more detail. Examples of cyan dyes include C. I. Acid Blue 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 199, 203, 204, 205, 229, 234, 236, and 249; C. I. Direct Blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, and 249; C. I. Reactive Blue 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43, 44, and 46; C. I. Food Blue 1 and 2; C. I. Basic Blue 9, 25, 28, 29, and 44; and the like.

Examples of magenta dyes include C. I. Acid Red 1, 6, 8, 9, 13, 14, 18, 26, 27, 32, 35, 37, 42, 51, 52, 57, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 249, 252, 254, 262, 265, 274, 282, 289, 303, 317, 320, 321, and 322; C. I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, and 231; C. I. Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, and 64; C. I. Food Red 7, 9, and 14; and the like.

Examples of yellow dyes include C. I. Acid Yellow 1, 3, 11, 17, 19, 23, 25, 29, 36, 38, 40, 42, 44, 49, 59, 61, 70, 72, 75, 76, 78, 79, 98, 99, 110, 111, 127, 131, 135, 142, 162, 164, and 165; C. I. Direct Yellow 1, 8, 11, 12, 24, 26, 27, 33, 39, 44, 50, 58, 85, 86, 87, 88, 89, 98, 110, 132, 142, and 144; Reactive Yellow 1, 2, 3, 4, 6, 7, 11, 12, 13, 14, 15, 16, 17, 18, 22, 23, 24, 25, 26, 27, 37, and 42; C. I. Food Yellow 3 and 4; and the like.

Examples of black dyes include C. I. Direct Black 1, 7, 19, 32, 51, 71, 108, 146, 154, and 166; and the like.

Examples of dyes other than the cyan, magenta, yellow and black dyes include C. I. Acid Green 7, 12, 25, 27, 35, 36, 40, 43, 44, 65, and 79; C. I. Direct Green 1, 6, 8, 26, 28, 30, 31, 37, 59, 63, and 64; C. I. Reactive Green 6 and 7; C. I. Direct Violet 2, 48, 63, and 90; C. I. Reactive Violet 1, 5, 9, and 10; and the like.

As the pigment, either an inorganic pigment or an organic pigment may be used.

Examples of organic pigments include an azo pigment (e.g., an azo lake pigment, an insoluble azo pigment, a condensed azo pigment, a chelating azo pigment, etc.); a polycyclic pigment (e.g., a phthalocyanine pigment, a perylene pigment, a perinone pigment, an anthraquinone pigment, a quinacridone pigment, a dioxazine pigment, an indigo pigment, a thioindigo pigment, an isoindolinone pigment, a quinofuranone pigment, etc.), a dye chelate (e.g., a basic dye-based chelate, an acid dye-based chelate, etc.), a nitro pigment, a nitroso pigment, an aniline black pigment, and the like.

Examples of inorganic pigments include titanium oxide, zinc oxide, zinc sulfide, white lead, calcium carbonate, settleable barium sulfate, white carbon, alumina white, kaolin clay, talc, bentonite, black iron oxide, cadmium red, red iron oxide, molybdenum red, molybdate orange, chrome vermillion, chrome yellow, cadmium yellow, yellow iron oxide, titanium yellow, chromium oxide, viridian, titanium cobalt green, cobalt green, cobalt chrome green, victoria green, ultramarine, Prussian blue, cobalt blue, cerulean blue, cobalt silica blue, cobalt zinc silica blue, manganese violet, cobalt violet, and the like.

More specifically, examples of black-type pigments include carbon black pigments (C. I. pigment black 7) such as furnace black, lamp black, acetylene black, channel black and the like; metal pigments such as copper, iron (C. I. pigment black 11), and the like; metal oxide pigments such as titanium oxide and the like; organic pigments such as aniline black (C. I. pigment black 1); and the like.

Examples of cyan-type pigments include C. I. pigment blue 1, 2, 3, 15:1, 15:3, 15:4, 15:6, 16, 21, 22, 60, and 64; and the like.

Examples of magenta-type pigments include C. I. pigment red 5, 7, 9, 12, 31, 48, 49, 52, 53, 57, 97, 112, 120, 122, 146, 147, 149, 150, 168, 170, 177, 178, 179, 184, 188, 202, 206, 207, 209, 238, 242, 254, 255, 264, 269, and 282; C. I. pigment violet 19, 23, 29, 30, 32, 36, 37, 38, 40, and 50; and the like.

Examples of yellow-type pigments include C. I. pigment yellow 1, 2, 3, 12, 13, 14, 16, 17, 20, 24, 74, 83, 86, 93, 94, 95, 109, 110, 117, 120, 125, 128, 129, 137, 138, 139, 147, 148, 150, 151, 154, 155, 166, 168, 180, 185, and 213; and the like.

Examples of other pigments include C. I. pigment green 7, 10, and 36; C. I. pigment brown 3, 5, 25, and 26; C. I. pigment orange 2, 5, 7, 13, 14, 15, 16, 24, 34, 36, 38, 40, 43, 62, 63, 64, and 71; and the like.

In addition, a pigment including a hydrophilic group such as a carboxyl group, a sulfonic acid group, a phosphonic acid group, a hydroxyl group or the like at a surface (so-called “self-dispersing pigment”) may be used. Examples of carbon black-type self-dispersing pigments include CAB-O-JET 200, 300, 352K, and 400 (produced by Cabot Corporation); and the like. Examples of cyan-type self-dispersing pigments include CAB-O-JET 250C, 450C, and 554B (produced by Cabot Corporation); and the like. Examples of magenta-type self-dispersing pigments include CAB-O-JET 260M, 265M, and 465M (produced by Cabot Corporation); and the like. Examples of yellow-type self-dispersing pigments include CAB-O-JET 270Y, 470Y, and 740Y (produced by Cabot Corporation); and the like. As the coloring material (B), a self-dispersing pigment, which is dispersible in the water (A) with no use of a dispersant, is preferable.

The content of the coloring material (B) in the inkjet ink according to a preferred embodiment of the present invention is preferably 0.1% by mass or greater, more preferably 0.5% by mass or greater, and still more preferably 1% by mass or greater as the solid quantity (solid content concentration). The content of the coloring material (B) in the inkjet ink according to a preferred embodiment of the present invention is preferably 10% by mass or less, more preferably 7.5% by mass or less, and still more preferably 5% by mass or less as the solid quantity (solid content concentration).

In this specification, the “water-soluble organic solvent” used as the water-soluble organic solvent component (C) refers to an organic solvent having a solubility of 500 g/L or greater with respect to water at 20° C. A preferable water-soluble organic solvent is uniformly miscible in water at any ratio at 20° C.

An inkjet ink according to a preferred embodiment of the present invention preferably includes 3-methoxy-1-butanol as the water-soluble organic solvent component (C). The use of 3-methoxy-1-butanol as the water-soluble organic solvent component (C) improves the drying property of the inkjet ink at a low temperature and thus allows the inkjet ink to be dried very quickly. The content of 3-methoxy-1-butanol in the inkjet ink according to a preferred embodiment of the present invention is 8% by mass or greater. If the content of 3-methoxy-1-butanol is less than 8% by mass, the effect of improving the drying property at a low temperature is not sufficiently provided, and the waterproofness and the image quality are not sufficiently high when the inkjet ink is dried at a low temperature. The content of 3-methoxy-1-butanol is preferably 10% by mass or greater, more preferably 13% by mass or greater, and still more preferably 18% by mass or greater. If the content of 3-methoxy-1-butanol is too high, the viscosity of the ink tends to be increased. Therefore, the content of 3-methoxy-1-butanol is preferably 50% by mass or less, more preferably 40% by mass or less, and still more preferably 35% by mass or less.

The water-soluble organic solvent component (C) may include another water-soluble organic solvent in addition to 3-methoxy-1-butanol (boiling point: about 158° C.). As the water-soluble organic solvent other than 3-methoxy-1-butanol, any water-soluble organic solvent known as a water-soluble organic solvent for aqueous inkjet inks may be used with no specific limitation. From the point of view of the quick drying property of the ink, the fixation of the ink and the image quality, a water-soluble organic solvent other than 3-methoxy-1-butanol preferably has a boiling point of 220° C. or lower.

Examples of the water-soluble organic solvents having a boiling point of 220° C. or lower include diols including ethylene glycol (boiling point: about 196° C.), propylene glycol (boiling point: about 188° C.), 1,3-propanediol (boiling point: about 213° C.), 1,2-butanediol (boiling point: about 194° C.), 2,3-butanediol (boiling point: about 183° C.), 1,3-butanediol (boiling point: about 208° C.), 2,2-dimethyl-1,3-propanediol (boiling point: about 208° C.), 2-methyl-1,3-propanediol (boiling point: about 213° C.), 1,2-pentanediol (boiling point: about 206° C.), 2,4-pentanediol (boiling point: about 201° C.), 2-methyl-2,4-pentanediol (boiling point: about 198° C.), and the like; dipropyleneglycolmonomethylether (boiling point: about 190° C.); propyleneglycol-n-butylether (boiling point: about 171° C.); propyleneglycol-t-butylether (boiling point: about 153° C.); diethyleneglycolmethylether (boiling point: about 194° C.); ethyleneglycol-n-propylether (boiling point: about 150° C.); ethyleneglycol-n-butylether (boiling point: about 171° C.); 3-methoxy-3-methyl-1-butanol (boiling point: about 174° C.); 1-ethoxy-2-propanol (boiling point: about 132° C.); and the like. These solvents may be used independently, or any two such solvents may be combined at any ratio.

The water-soluble organic solvent component (C) is preferably a diol, which improves the moisture retaining property of the inkjet ink. The content of the diol in the inkjet ink according to a preferred embodiment of the present invention is preferably 1.5% by mass or greater, and more preferably 3% by mass or greater. The content of the diol in the inkjet ink according to a preferred embodiment of the present invention is preferably 20% by mass or less, and more preferably 10% by mass or less.

If the content of the water-soluble organic solvent component (C) is too low in the inkjet ink, the drying property tends to be decreased, and the wettability of the inkjet ink with respect to the non-absorbent substrate is decreased. The decrease in the wettability may decrease the fixation and the image quality. Therefore, the content of the water-soluble organic solvent component (C) in the inkjet ink according to a preferred embodiment of the present invention is preferably 8% by mass or greater, more preferably 13% by mass or greater, still more preferably 18% by mass or greater, and most preferably 22% or greater. By contrast, if the content of the water-soluble organic solvent component (C) is too high, the viscosity of the ink tends to be increased. Therefore, the content of the water-soluble organic solvent component (C) in the inkjet ink according to a preferred embodiment of the present invention is preferably 45% by mass or less, more preferably 40% by mass or less, and still more preferably 38% by mass or less.

Resin microparticles (D) form a binder component that increases the fixation to the non-absorbent substrate and the tolerance of an ink film.

For the resin microparticles (D), any known resin that is usable with aqueous inkjet inks may be used with no specific limitation. Examples of resins that form the resin microparticles include a urethane resin, a polyester resin, an acrylic resin, a vinyl acetate resin, a polyethylene resin, a polypropylene resin, a fluoroolefin resin, a butadiene resin, a styrene resin, a styrene-butadiene resin, a styrene-acrylic resin, a vinyl chloride resin, an acrylic-silicone resin, and the like.

The resin microparticles (D) do not need to be made of one type of resin, and may be made of two or more types of resins. For example, core-shell type microparticles including a core portion and a shell portion having different resin compositions from each other, microparticles obtained as a result of emulsion polymerization, with pre-produced acrylic microparticles (seed particles), of a different type of monomer in order to control the particle size, or the like may be used. Alternatively, hybrid resin microparticles obtained as a result of chemical bonding of resin particles made of different resins, for example, microparticles made of an acrylic resin and microparticles made of a urethane resin, may be used.

The resin microparticles (D) preferably include an acrylic resin or a urethane resin in at least a surface portion because these resins have a high fixing ability and a high ink stability. The resin microparticles (D) more preferably include a urethane resin in at least the surface portion.

There is no specific limitation on the volume-average particle size of the resin microparticles (D). The volume-average particle size is preferably 10 to 1000 nm, more preferably 10 to 200 nm, and still more preferably 10 to 50 nm. The volume-average particle size may be determined by use of, for example, a particle size distribution meter.

The content of the resin microparticles (D) in the inkjet ink according to a preferred embodiment of the present invention is preferably 3% by mass or greater, and more preferably 5% by mass or greater as the solid quantity (solid content concentration). The content of the resin microparticles (D) in the inkjet ink according to a preferred embodiment of the present invention is preferably 15% by mass or less, and more preferably 12% by mass or less as the solid quantity (solid content concentration).

The surfactant (E) is a component that adjusts the surface tension and the interfacial tension to be adequate. As the surfactant (E), any known surfactant usable with aqueous inkjet inks may be used with no specific limitation. Examples of such surfactants include an anionic surfactant, a nonionic surfactant, a cationic surfactant, an amphoteric surfactant, and the like. Among these surfactants, an anionic surfactant and a nonionic surfactant are preferable, and a nonionic surfactant is more preferable.

Examples of nonionic surfactants include a sorbit-based surfactant, an acetyleneglycol-based surfactant, a sorbitan-based surfactant, a silicone-based surfactant, a polyoxyethylenealkylether-based surfactant, and the like. Among these surfactants, an acetyleneglycol-based surfactant and a silicone-based surfactant, which easily adjust the static surface tension, are preferable. A silicone-based surfactant, which easily adjusts the static surface tension with a small amount, is more preferable.

As the acetyleneglycol-based surfactant, any known acetyleneglycol-based surfactant may be used with no specific limitation. Examples of acetyleneglycol-based surfactants include 2,4,7,9-tetramethyl-5-decyne-4,7-diol, 3,6-dimethyl-4-octyne-3,6-diol, 3,5-dimethyl-1-hexyne-3-ol, 2,4-dimethyl-5-hexyne-3-ol, and the like. The acetyleneglycol-based surfactant is also available commercially. Examples of such commercially available acetyleneglycol-based surfactants include Surfynol 104, 104E, 104H, 104A, 104BC, 104DPM, 104PA, 104PG-50, 104S, 420, 440, 465, 485, SE, SE-F, 504, 61, 82, DF37, DF110D, CT111, CT121, CT131, CT136, TG, and GA (produced by Nisshin Chemical Industry Co., Ltd.); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (produced by Nisshin Chemical Industry Co., Ltd.); Acetylenol E00, E13T, E40, E60, E81, E100, and E200 (produced by Kawaken Fine Chemicals Co., Ltd.); and the like.

As the silicone-based surfactant, any known silicone-based surfactant may be used with no specific limitation. The silicone-based surfactant is also available commercially. Examples of such commercially available silicone-based surfactants include BYK-306, BYK-307, BYK-333, BYK-345, BYK-346, BYK-347, BYK-348, and BYK-349 (produced by BYK Japan, K.K.); KF-351A, KF-352A, KF-353, KF-354L, KF-355A, KF-615A, KF-945, KF-640, KF-642, KF-643, KF-6020, X-22-4515, KF-6011, and KF-6012 (produced by Shin-Etsu Chemical Co., Ltd.); Silface SAG002, SAG005, SAG503A, and SAG008 (produced by Nisshin Chemical Industry Co., Ltd.); and the like. As the silicone-based surfactant, a polyether-modified silicon surfactant is preferable.

The content of the surfactant (E) in an inkjet ink according to a preferred embodiment of the present invention is 2% by mass or less. As the content of the surfactant (E) is increased, the quick drying property tends to be decreased. If the content of the surfactant (E) exceeds 2% by mass, a sufficient level of waterproofness is not provided. The content of the surfactant (E) is preferably 0.3% by mass or greater, more preferably 0.5% by mass or greater, and still more preferably 0.7% by mass or greater. The content of the surfactant (E) is preferably 1.8% by mass or less, more preferably 1.6% by mass or less, and still more preferably 1.4% by mass or less.

The inkjet ink according to a preferred embodiment of the present invention may include, in addition to the above components, an additive such as a preservative, a fungicide, a thickener, an anti-foam agent, a pH adjuster, a rust-inhibitor or the like in a range in which the effects of preferred embodiments of the present invention are not significantly spoiled.

In an inkjet ink according to a preferred embodiment of the present invention, the static surface tension determined by the Wilhelmy method is preferably about 27.0 mN/m or less at 25° C. When the static surface tension exceeds about 27.0 mN/m, ink bleeding of the image occurs, which decreases the image quality. The static surface tension is measured as follows by the Wilhelmy method. When the measuring probe touches a surface of the liquid, the liquid rises on the measuring probe. At this point, the surface tension acts along the periphery of the measuring probe and attempts to pull the measuring probe into the liquid. The force of pulling in the measuring probe is read, so that the surface tension is measured. Therefore, for example, the static surface tension may be measured at 25° C. by use of a platinum measuring probe and a known surface tension meter. The value of the static surface tension may be adjusted by appropriately selecting the type of the surfactant (E) and appropriately adjusting the amount of the surfactant (E).

An inkjet ink according to a preferred embodiment of the present invention may be produced by mixing the components according to a known method. For example, the inkjet ink according to a preferred embodiment of the present invention may be produced by mixing water, an emulsion containing a coloring material, a water-soluble organic solvent, an emulsion containing resin microparticles, a surfactant, and other components uniformly by use of a known mixing device or a known stirring device.

An inkjet ink according to a preferred embodiment of the present invention is, when used to print on a PVC substrate, is high in each of the quick drying property, the waterproofness and the image quality even when being dried at a relatively low temperature (e.g., about 50° C.). Especially regarding the image quality, ink bleeding is significantly reduced or prevented. The inkjet inks according to preferred embodiments of the present invention are especially preferably useful for printing on a PVC substrate, and are also usable for printing (image formation) on a substrate other than the PVC substrate, for example, non-absorbent substrates such as a PET substrate, a surface-treated (corona-treated) polyethylene (PE) substrate, a surface-treated (corona-treated) polypropylene (PP) substrate, a polystyrene substrate and the like; and paper substrates such as art paper, coated paper, cast paper, wood-free paper, synthetic paper, paper for inkjet, and the like. The inkjet inks according to preferred embodiments of the present invention are suitably useful for printing on a non-absorbent substrate. The inkjet inks according to preferred embodiments of the present invention are high in the quick drying property, and thus are preferable for printing on a medium including a non-absorbent substrate (especially, a PVC substrate) and a pressure-sensitive adhesive layer (e.g., adhesive label, etc.). The inkjet ink does not need to be dried at a high temperature, and therefore, when used on such a medium, prevents the substrate and the pressure-sensitive adhesive layer from being shifted with respect to each other, which would otherwise be caused by the pressure-sensitive adhesive layer being softened by heat. Therefore, a printer having a print-and-cut function, when using the inkjet inks according to preferred embodiments of the present invention, provides printed items at a high productivity with no need to heat the medium to a high temperature before and after the drying.

In another aspect, a preferred embodiment of the present invention relates to an inkjet recording method including a step of ejecting the above-described inkjet ink toward a medium including a non-absorbent substrate (hereinafter, also referred to as an “ejection step”) and a step of drying the inkjet ink ejected on the medium to form an ink film (hereinafter, also referred to as a “film formation step”).

Usable as the non-absorbent substrate are a PVC substrate, a PET substrate, a surface-treated (corona-treated) PE substrate, a surface-treated (corona-treated) PP substrate, a polystyrene substrate and the like. Among these substrates, a PVC substrate is preferable.

A preferable medium includes a non-absorbent substrate and a pressure-sensitive adhesive layer (e.g., adhesive label, etc.). The medium may further include a release layer.

In the ejection step, the inkjet ink is ejected toward the non-absorbent substrate of the medium. An inkjet recording method according to a preferred embodiment of the present invention may further include a step of heating the medium before the ejection step. When the medium is heated, the surface temperature of the medium is typically about 30° C. to about 80° C. Alternatively, the surface temperature of the medium may be of a relatively low temperature range among the temperature ranges to which the ink is heated by a conventional inkjet recording method, for example, about 30° C. to about 60° C. (especially, about 30° C. to about 55° C.)

In the film formation step, the medium may be heated in order to promote drying. When the medium is heated, the surface temperature of the medium is typically about 30° C. to about 80° C. Alternatively, the surface temperature of the medium may be of a relatively low temperature range among the temperature ranges to which the ink is heated by a conventional inkjet recording method, for example, about 30° C. to about 60° C. (especially, about 30° C. to about 55° C.)

An inkjet recording method according to a preferred embodiment of the present invention preferably includes a step of cutting the medium (also referred to as a “cutting step”) after the film forming step. In this case, it is advantageous that the inkjet recording method is performed using an inkjet recording device including a print-and-cut function. The inkjet recording method including the cutting step is suitable for printing on a medium including a non-absorbent substrate and a pressure-sensitive adhesive layer. According to a preferred embodiment of the method, an inkjet ink has a high drying property, and thus does not need to be heated to a high temperature at which the non-absorbent substrate and the pressure-sensitive adhesive layer are shifted with respect to each other. Thus, the production yield is raised.

An inkjet recording method according to a preferred embodiment of the present invention is performed preferably using an inkjet recording device including a conveyor that transports a medium including a non-absorbent substrate, a heater that heats the transported medium, an ejector that ejects inkjet ink toward the heated medium, and an ink container that contains the inkjet ink and supplies the inkjet ink to the ejector. The inkjet ink is preferably the above-described inkjet ink.

As an example, an inkjet recording device according to a preferred embodiment will be described with respect to the FIGURE. The FIGURE is a conceptual view of an inkjet recording device 100 according to a preferred embodiment of the present invention. The inkjet recording device 100 includes a conveyor 20 that transports a medium 10 including a non-absorbent substrate. The conveyor 20 preferably includes a supply roller 21, a take-up roller 22 and a transportation roller 23. The medium 10 is fed from the supply roller 21, passes over a platen 30 while being transported by the transportation roller 23, and is taken up by the take-up roller 22. Therefore, in this preferred embodiment, a direction of transporting the medium 10 is from the supply roller 21 toward the take-up roller 22. The medium 10 is shown for the sake of convenience, and is not an element of the inkjet recording device 100. As the medium 10, a medium including a PVC substrate is preferable.

The inkjet recording device 100 preferably includes a heater 40. The heater 40 preferably functions as a preheater to heat the medium 10. The heater 40 includes, for example, a contact-heat sheet heater, a radiation heater that radiates infrared waves or microwaves, or a warm air heater. The heater 40 may be located above or below the medium 10, or may be located above and below the medium 10. Heating conditions for the heater 40 are set such that the temperature of the medium 10 is, for example, about 30° C. or higher and lower than a softening point of the medium (such that the temperature of the medium 10 is preferably about 30° C. to about 80° C., more preferably about 30° C. to about 60° C., and still more preferably about 30° C. to about 55° C.)

The inkjet recording device 100 includes an ejector 50 that ejects the inkjet ink 11 toward the medium 10. The ejector 50 is located downstream with respect to the heater 40 in the transportation direction of the medium 10. The ejector 50 includes an inkjet head that ejects the inkjet ink 11 in the form of liquid drops from a microscopic nozzle that uses, for example, vibration of a piezoelectric element. The inkjet recording device 100 includes an ink container 60. The ink container 60 is connected with the ejector 50. The ink container 60 includes, for example, an ink cartridge. Before being ejected, the inkjet ink 11 is contained in the ink container 60. The inkjet ink 11 contained in the ink container 60 is supplied to the ejector 50 when necessary. The inkjet ink 11 is preferably the above-described aqueous inkjet ink.

The inkjet recording device 100 preferably includes a drier 70 that dries the ejected inkjet ink 11. The drier 70 is located downstream with respect to the ejector 50 in the transportation direction of the medium 10, and is preferably provided in a carriage 71. The drier 70 includes, for example, a heater such as a radiation heater that radiates infrared waves or microwaves, a warm air heater or the like, or an air blowing drier. Drying conditions for the drier 70 are set such that the inkjet ink 11 attached to the medium 10 is dried to form an image. Drying conditions are appropriately selected in accordance with the type and the amount of the solvent contained in the inkjet ink 11. The drier 70 is preferably a heater, and heating conditions for the heater are set such that the temperature of the medium 10 is, for example, about 30° C. or higher and lower than a softening point of the medium (such that the temperature of the medium 10 is preferably about 30° C. to about 80° C., more preferably about 30° C. to about 60° C., and still more preferably about 30° C. to about 55° C.)

Hereinafter, various preferred embodiments of the present invention will be described in detail by way of examples. The present invention is not limited to any of the following examples.

The components shown in Table 1 through Table 3 were mixed uniformly at a mass ratio shown in the tables to obtain examples and comparative examples of inkjet inks. The static surface tension of the obtained inkjet ink of each of the examples and the comparative examples was measured by the following method. The obtained inkjet ink was used to perform printing on a PVC film using an inkjet printer, and was evaluated regarding the quick drying property, the waterproofness and the image quality by the methods described below. The surface temperature of the PVC film was raised to 30° C. to 45° C. before the printing, and was raised to 40° C. to 50° C. after the printing. For the evaluation of the quick drying property and the waterproofness, a fully plain image was formed under the conditions that the amount of the ink was 22 pl per drop and that the resolution was 740 dpi×740 dpi. For the evaluation of the image quality, a fully plain image with a 5 pt white letter on a colored background was made under the conditions that the amount of the ink was 22 pl per drop and that the resolution was 740 dpi×740 dpi. The evaluation results are shown in Table 1 through Table 3.

### Measurement of the Static Surface Tension

A platinum plate was wetted with the ink at 25° C., and the surface tension was measured by use of a surface tension meter according to the Wilhelmy method.

### Evaluation on the Quick Drying Property

After the printing, the plain image was heated. When 30 seconds lapsed from the start of the heating, the plain image was scraped with a cotton swab, and the states of the plain image and the cotton swab were observed. Based on the observation results, the quick drying property was evaluated with the following criteria, and “◯” and “Δ” indicate that the test was passed.

◯: No ink was attached to the cotton swab, and the plain image remained the same.

Δ: No ink was attached to the cotton swab, but the plain image was scratched.

X: Ink was attached to the cotton swab, and ink was removed from the plain image.

### Evaluation on the Waterproofness

Cotton wetted with water was attached to a JSPS (Japan Society for the Promotion of Science) tester. The cotton, with a weight of 500 g, was moved reciprocally 100 times on an ink film of the plain image. Then, the state of the ink film was observed. Based on the observation results, the waterproofness was evaluated with the following criteria, and “◯” and “Δ” indicate that the test was passed.

◯: No ink film was removed.

Δ: Only a portion of the ink film was removed.

X: Half or more of the ink film was removed.

Evaluation on the Ink Bleeding from the Image

The degree of ink bleeding from the image with a white letter “L” formed of ink dots on a colored background was visually observed. Based on the observation results, the degree of ink bleeding was evaluated with the following criteria, and “◯” and “Δ” indicate that the test was passed.

◯: The white letter was highly visually identifiable.

Δ: Ink was slightly bleeding into the white letter, but the white letter was visually identifiable.

X: Ink was bleeding and the white letter was not visually identifiable.

TABLE 1

| | Remarks | Example 1 | Example 2 | Example 3 | Example 4 | Example 5 |
|---|---|---|---|---|---|---|
| CAB-O-JET 260M (10% · aq) | Color material | | | | | |
| CAB-O-JET 250C (10% · aq) | Color material | 26 | 26 | 26 | 26 | 26 |
| Propyleneglycol | Boiling point 188° C. | 5 | 5 | 5 | 5 | 5 |
| 3-methoxy-1-butanol | Boiling point 158° C. | 20 | 20 | 20 | 10 | 15 |
| SAG002 | Silicone-based | 0.4 | 0.8 | 1.2 | 1.6 | 2.0 |
| Exp. 4200 | Acetyleneglycol-based | | | | | |
| E1010 | Acetyleneglycol-based | | | | | |
| Vinyblan 715S (25% · aq) | Vinyl chloride-urethane | 32 | 32 | 32 | 32 | 32 |
| | Core-shell | | | | | |
| PE1126 (41% · aq) | Acrylic resin | | | | | |
| Water | Separately added | 16.6 | 16.2 | 15.8 | 25.4 | 20.0 |
| Total | | 100 | 100 | 100 | 100 | 100 |
| Total amount of water | (A) | 64.0 | 63.6 | 63.2 | 72.8 | 67.4 |
| Color material | (B) | 2.6 | 2.6 | 2.6 | 2.6 | 2.6 |
| Total amount of water-soluble | (C) | 25 | 25 | 25 | 15 | 20 |
| organic solvent | | | | | | |
| 3-methoxy-1-butanol | | 20 | 20 | 20 | 10 | 15 |
| Resin particles | (D) | 8.0 | 8.0 | 8.0 | 8.0 | 8.0 |
| Surfactant | (E) | 0.4 | 0.8 | 1.2 | 1.6 | 2.0 |
| Surface tension mN/m | | 26.6 | 25.4 | 24.8 | 24.2 | 24.1 |
| Quick drying property | | ∘ | ∘ | ∘ | ∘ | Δ |
| Waterproofness | | ∘ | ∘ | ∘ | Δ | Δ |
| Ink bleeding | | Δ | ∘ | ∘ | ∘ | ∘ |

TABLE 2

| | Remarks | Example 6 | Example 7 | Example 8 | Example 9 | Example 10 | Example 11 |
|---|---|---|---|---|---|---|---|
| CAB-O-JET 260M (10% · aq) | Color material | | | | | | 26 |
| CAB-O-JET 250C (10% · aq) | Color material | 26 | 26 | 26 | 26 | 26 | |
| Propyleneglycol | Boiling point 188° C. | 5 | 5 | 5 | 5 | 5 | 5 |
| 3-methoxy-1-butanol | Boiling point 158° C. | 20 | 20 | 20 | 10 | 30 | 30 |
| SAG002 | Silicone-based | | 0.6 | 0.8 | 0.8 | 0.8 | 0.8 |
| Exp. 4200 | Acetyleneglycol-based | 0.8 | | | | | |
| E1010 | Acetyleneglycol-based | | 0.4 | | | | |
| Vinyblan 715S (25% · aq) | Vinyl chloride-urethane | 32 | 32 | | 32 | 32 | 32 |
| | Core-shell | | | | | | |
| PE1126 (41% · aq) | Acrylic resin | | | 19.5 | | | |
| Water | Separately added | 16.2 | 16.0 | 28.7 | 26.2 | 6.2 | 6.2 |
| Total | | 100 | 100 | 100 | 100 | 100 | 100 |
| Total amount of water | (A) | 63.6 | 63.4 | 63.6 | 73.6 | 53.6 | 53.6 |
| Color material | (B) | 2.6 | 2.6 | 2.6 | 2.6 | 2.6 | 2.6 |
| Total amount of water-soluble | (C) | 25 | 25 | 25 | 15 | 35 | 35 |
| organic solvent | | | | | | | |
| 3-methoxy-1-butanol | | 20 | 20 | 20 | 10 | 30 | 30 |
| Resin particles | (D) | 8.0 | 8.0 | 8.0 | 8.0 | 8.0 | 8.0 |
| Surfactant | (E) | 0.8 | 1.0 | 0.8 | 0.8 | 0.8 | 0.8 |
| Surface tension mN/m | | 26.5 | 25.6 | 25.5 | 25.4 | 25.5 | 25.6 |
| Quick drying property | | ∘ | ∘ | ∘ | Δ | ∘ | ∘ |
| Waterproofness | | Δ | ∘ | Δ | ∘ | ∘ | ∘ |
| Ink bleeding | | ∘ | ∘ | ∘ | Δ | ∘ | ∘ |

TABLE 3

| | | Comparative | Comparative | Comparative |
|---|---|---|---|---|
| | Remarks | example 1 | example 2 | example 3 |
| CAB-O-JET 260M (10% · aq) | Color material | | | |
| CAB-O-JET 250C (10% · aq) | Color material | 26 | 26 | 26 |
| Propyleneglycol | Boiling point 188° C. | 5 | 5 | 25 |
| 3-methoxy-1-butanol | Boiling point 158° C. | 20 | 20 | |
| SAG002 | Silicone-based | 2.4 | | 0.8 |
| Exp. 4200 | Acetyleneglycol-based | | | |
| E1010 | Acetyleneglycol-based | | 0.8 | |
| Vinyblan 715S (25%•aq) | Vinyl chloride-urethane | 32 | 32 | 32 |
| | Core-shell | | | |
| PE1126 (41%•aq) | Acrylic resin | | | |
| Water | Separately added | 14.6 | 16.2 | 16.2 |
| Total | | 100 | 100 | 100 |
| Total amount of water | (A) | 62.0 | 63.6 | 63.6 |
| Color material | (B) | 2.6 | 2.6 | 2.6 |
| Total amount of water-soluble | (C) | 25 | 25 | 25 |
| organic solvent | | | | |
| 3-methoxy-1-butanol | | 20 | 20 | 0 |
| Resin particles | (D) | 8.0 | 8.0 | 8.0 |
| Surfactant | (E) | 2.4 | 0.8 | 0.8 |
| Surface tension mN/m | | 24.0 | 27.2 | 25.5 |
| Quick drying property | | Δ | ◯ | X |
| Waterproofness | | X | ◯ | X |
| Ink bleeding | | ◯ | X | X |

The numerical value for each component in the tables represents the mass ratio.

CAB-O-JET260M (produced by Cabot Corporation): self-dispersing pigment (aqueous emulsion contained at a solid content of 10% by mass)

CAB-O-JET250C (produced by Cabot Corporation): self-dispersing pigment (aqueous emulsion contained at a solid content of 10% by mass)

SAG002 (produced by Nisshin Chemical Industry Co., Ltd.): silicone-based surfactant “Silface SAG002”

Exp. 4200 (produced by Nisshin Chemical Industry Co., Ltd.): acetyleneglycol-based surfactant “Olfine Exp. 4200”

E1010 (produced by Nisshin Chemical Industry Co., Ltd.): acetyleneglycol-based surfactant “Olfine E1010”

Vinyblan 715S (produced by Nisshin Chemical Industry Co., Ltd.): aqueous emulsion of poly(vinyl chloride)-polyurethane core-shell particles (solid content: 25% by mass)

PE1126 (produced by Seiko PMC Corporation): acrylic resin aqueous emulsion (solid content: 41.5% by mass)

It is seen from Table 1 and Table 2, the inkjet ink in each of examples 1 through 11 in the scope of the preferred embodiments of the present invention has a high quick drying property, waterproofness, and image quality even when being dried at a relatively low temperature.

By contrast, it is seen from the results of comparative example 1 in Table 3 that when the content of the surfactant (E) in the ink exceeds 2% by mass, the waterproofness is deteriorated. It is seen from the results of comparative example 2 that when the static surface tension exceeds 27.0 mN/m, the ink bleeding from the image is excessive and thus the image quality is deteriorated. A reason for this is that gathering of dots occurs before the dots are sufficiently wet and expanded, so that the ink bleeds from the image. It is seen from the results of comparative example 3 that when the water-soluble organic solvent does not include 3-methoxy-1-butanol, each of the quick drying property, the waterproofness, and the image quality are deteriorated. This is caused mainly because the drying property at a low temperature is poor.

The present invention may be embodied in other forms without departing from the spirit or essential characteristics thereof. The preferred embodiments of the present invention disclosed in this specification are to be considered in all respects as illustrative and not limiting. The scope of the present invention is indicated by the appended claims rather than by the foregoing description, and all changes which are within the meaning and range of equivalency of the claims are intended to be embraced therein.

Inkjet inks according to the preferred embodiments of the present invention are especially preferably useful for printing on a PVC substrate, and are also useful for printing (image formation) on a substrate other than the PVC substrate, for example, non-absorbent substrates such as a PET substrate, a surface-treated (corona-treated) polyethylene (PE) substrate, a surface-treated (corona-treated) polypropylene (PP substrate), a polystyrene substrate and the like; and paper substrates such as art paper, coated paper, cast paper, wood-free paper, synthetic paper, paper for inkjet, and the like. The inkjet ink according to preferred embodiments of the present invention are suitably useful for printing on a non-absorbent substrate.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet ink comprising:
water;
a coloring material;
a water-soluble organic solvent component;
resin particles; and
a surfactant; wherein
the water-soluble organic solvent component includes 3-methoxy-1-butanol at a content of 8% by mass or greater of the inkjet ink;
the surfactant is included in the inkjet ink at a content of 2% by mass or less; and
the inkjet ink has a static surface tension, determined by the Wilhelmy method, of about 27.0 mN/m or less at 25° C.

2. The inkjet ink according to claim 1, wherein the surfactant is a silicone-based surfactant.

3. The inkjet ink according to claim 1, wherein at least a surface portion of the resin particles includes a urethane resin.

4. An inkjet recording method comprising the steps of:
ejecting the inkjet ink according to claim 1 toward a medium including a non-absorbent substrate; and
drying the inkjet ink ejected on the medium to form an ink film.

5. The inkjet recording method according to claim 4, wherein the non-absorbent substrate includes poly(vinyl chloride).

6. The inkjet recording method according to claim 4, wherein the medium further includes a pressure-sensitive adhesive layer.

7. An inkjet recording device comprising:
a conveyor that transports a medium including a non-absorbent substrate;
a heater that heats the transported medium;
an ejector that ejects inkjet ink toward the heated medium;
an ink container that contains the inkjet ink and supplies the inkjet ink to the ejector; and
the inkjet ink according to claim 1.
